(19) United States
(12) Patent Application Publication
(10) Pub. No.: US 2003/0135493 A1
(43) Pub. Date: Jul. 17, 2003

(54) Method and apparatus for consuming information based on a geographic location profile of a user

(76) Inventors: Jeffrey Phelan, Fairfax, VA (US); Christopher Rawbone, London (GB)

Correspondence Address: PATTON BOGGS LLP, ATTORNEYS AT LAW, 2550 M Street, NW, Washington, DC, 20037-1350, US

(21) Appl. No.: 10/072,962

(22) Filed: Feb. 12, 2002

Related U.S. Application Data
(60) Provisional application No. 60/347,865, filed on Jan. 15, 2002.

(51) Int. Cl. G06F 7/00

(52) U.S. Cl. 707/3

(57) ABSTRACT

A method is provided for consuming information based on a geographic location profile of a user. The method receives a first set of information, based on a geographic location of interest to a user. The method sends, through a network, the first set of information to assemble a geographic location profile of the user. The method receives, through the network, a second set of information, based on the geographic location profile of the user. The method then communicates the second set of information to the user. The geographic location profile of the user is based on the first set of information.

This application claims the benefit of U.S. Provisional Application No. 60/347,865, filed on Jan. 15, 2002.

### FIELD OF THE INVENTION

The present invention relates to network communications. More particularly, the present invention relates to consuming information based on a geographic location profile of a user.

### DESCRIPTION OF BACKGROUND INFORMATION

The Internet is a well-known, global network of cooperatively interconnected computer networks. The World Wide Web (“Web”) portion of the Internet is a collection of server computers that store documents (e.g., Web pages), which are typically accessible by the public. A Web page consists of text, graphic, audio/visual, and the like (e.g., multimedia). The Web pages on the servers are identified by a Uniform Resource Locator (“URL”). An Intranet is similar to the Internet. Intranets, however, restrict access to the network to users outside of a defined group, such as users who are not employees of a corporation. Hereinafter, any description of the Internet also is applicable to an Intranet.

FIG. 8 illustrates a simplified diagram of network communications. Client computers 10 connect to an Internet Service Provider (“ISP”) or a Network Service Provider (“NSP”) 50. The Internet Service Provider (“ISP”) provides Internet access to users of client computers 10, while the Network Service Provider (“NSP”) provides Internet access to the ISPs, as well as users of client computers 10. The ISP/NSP 50 includes a router 20 that connects to servers 40 through network 30 (e.g., Internet or Intranet). A browser, running on each of client computers 10, retrieves (or downloads) Web pages from servers 40. The browser allows the users of client computers 10 to navigate (or “browse”) between Web pages.

It is also known to organize, filter, and distribute, through the network 30, information such as sports information using key word classifications alone. This information is distributed through the network 30 for presentation, through client computers 10, to each and every end user of such service. At this time, the information is presented to end users based on filters implemented by the distributor, and not by the end users. Moreover, the information cannot be correlated or integrated with other information to create a uniquely personalized distribution of information to particular end users.

Presently, a supplier of information implements identical key word filters for each and every consumer of the information. The information currently is, in effect, distributed to an end user or to an end-user location in a blind manner. Distributors of information, including distributors of sports information, are totally unaware of who the end user itself is, and/or where the end user itself is physically located. Furthermore, the distributors are unaware of how such information about the end user influences what type(s) of information that end user is interested in.

A significant drawback of known methods of information searching, filtering, and distribution using only key words is that a small percentage of available information can be constantly recycled, while a large(r) percentage of available and useful information can be constantly overlooked and/or ignored. A further drawback is the failure of known methods to personalize the distribution of information to each and every end user. Accordingly, a disconnect presently exists between information distribution and consumption.

### SUMMARY OF THE INVENTION

In one implementation of the present invention, a method is provided for consuming information based on a geographic location profile of a user. The method receives a first set of information, based on a geographic location of interest to a user. The method sends, through a network, the first set of information to assemble a geographic location profile of the user. The method receives, through the network, a second set of information, based on the geographic location profile of the user. The method then communicates the second set of information to the user. The geographic location profile of the user is based on the first set of information.

### BRIEF DESCRIPTION OF THE DRAWINGS

FIG. 1 depicts a flowchart illustrating one embodiment for filtering information to end users;

FIG. 2 depicts exemplary data sets;

FIG. 3 depicts exemplary information communicated to end users;

FIG. 4 depicts one embodiment of a method for distributing information based on a geographic location profile of a user;

FIG. 5 depicts one embodiment of a method for distributing information based on a geographic location determined for the information;

FIG. 6 depicts one embodiment of a method for consuming information based on a geographic location profile of a user;

FIG. 7 depicts one embodiment of an apparatus for (i) distributing information based on a geographic location profile of a user, (ii) distributing information based on a geographic location determined for the information, and/or (iii) consuming information based on a geographic location profile of a user; and

FIG. 8 depicts a simplified diagram of network communications.

### DETAILED DESCRIPTION

One embodiment of the present invention augments traditional news, business, entertainment, and/or sports coverage by providing end users with the ability to adapt their information consumption on the basis of their individual needs, location, and/or profile. This embodiment enables an end user (e.g., an Internet-era sports fan) to receive, through a network, information (e.g., information on news, business, entertainment, sports, and/or people) based on who and/or where the user is. The end user's physical location, which may be manually and/or automatically updated, allows a further filter to receive, through the network, multiple types of information.

For example, if a Major League Baseball fan cheers for the New York Yankees and lives in Seattle, Wash., then news, editorial content, calendar, venue, event, statistical data, etc. related to the Yankees may be processed using a filter (e.g., team, players, stadium, and/or city filter), based on his or her Seattle location. In this way, information that is more meaningful to that end user can be customized to him or her. As such, the embodiment allows sports fans, among others, to continually “carry” their sports loyalties with them, and accommodate the connection between their location (e.g., present and/or past geographic location) and information consumption.

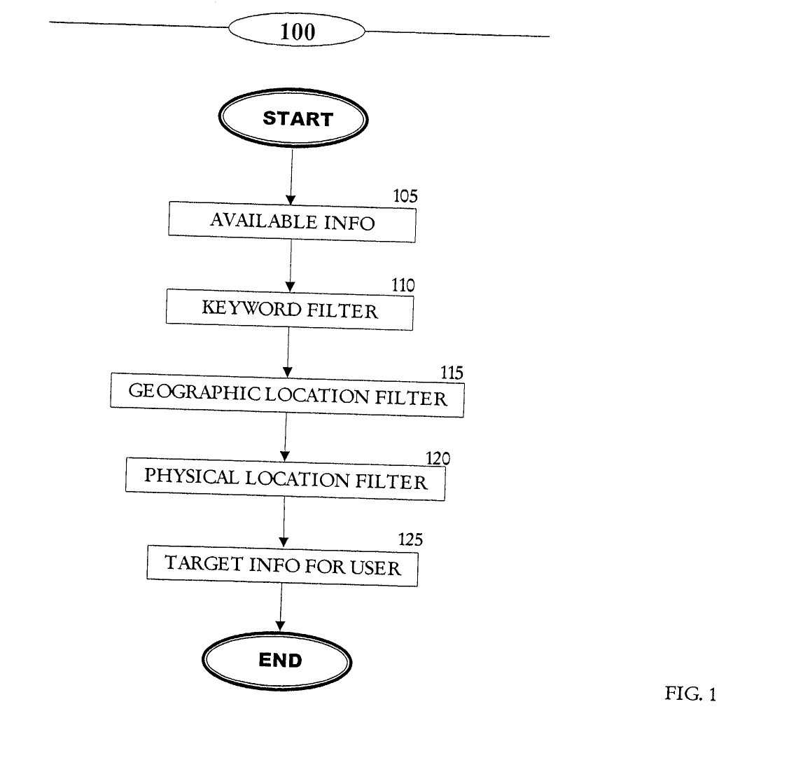

FIG. 1 depicts a flowchart 100 illustrating one embodiment for filtering information (e.g., sports information) to end users. In block 105, the flowchart 100 illustrates the available information that may be communicated to an end user. In block 110, the flowchart 100 illustrates a key word filter based on a key word(s), for example, determined (directly or indirectly) by the end user. In block 115, the flowchart 100 illustrates a geographic location filter based on a geographic location of interest to the end user, for example, determined as such by the end user itself. In block 120, the flowchart 100 illustrates a physical location filter based on a physical location of the end user. In block 125, the flowchart 100 illustrates information customized (e.g., uniquely customized) for the end user on basis of key word(s) determined by the end user, geographic location(s) of interest to the end user, and/or a physical location of the end user. A geographic location profile of the end user may include the contents of the key word filter, the geographic location filter, and/or the physical location filter of the end user.

The detailed description then refers to the accompanying drawings that illustrate several embodiments of the present invention. Other embodiments are possible and modifications may be made to the embodiments without departing from the spirit and scope of the invention. Therefore, the detailed description is not meant to limit the invention. Rather the scope of the invention is defined by the appended claims, and their equivalents.

One embodiment illustrates a method that correlates data feeds (e.g., sports data feeds) using location-based classification. The method appends (e.g., “tags”) specific elements of distinct (sports) news and data feeds with a location-specific identification. This location-specific identification allows relevant but unrelated and disparate data, which normally would not be associated, to be correlated, organized, and/or distributed through a network. The location identification, in effect, functions as a decoder that allows seemingly unrelated but relevant information to be communicated to an end user, and to other data within a data feed. As such, this method allows filtering, organizing, and distribution of information such as, for example, sports information, which may be specifically matched (e.g., compared) to an end user's geographic location profile, and/or the end user's geographic location. The information deemed relevant to the end user may be communicated, through the network, to a mobile, wireless, and/or browser-based device used by the end user.

A plurality of data feed types may be stored in a database for tagging, for example, using Extensible Markup Language (“XML”). In general terms, XML is a way to create common and consistent information formats and share both the format and the information on the network or elsewhere. Simply put, XML is one way to express documents in terms of a data structure. The data feeds may include scores and results, statistics, historical data, live data, news and editorials, event information, venue information, calendar information, and trivia, among others. It is known to tag and organize distinct data feeds using key words (see above). The method, however, allows tagging data feeds using a location identification.

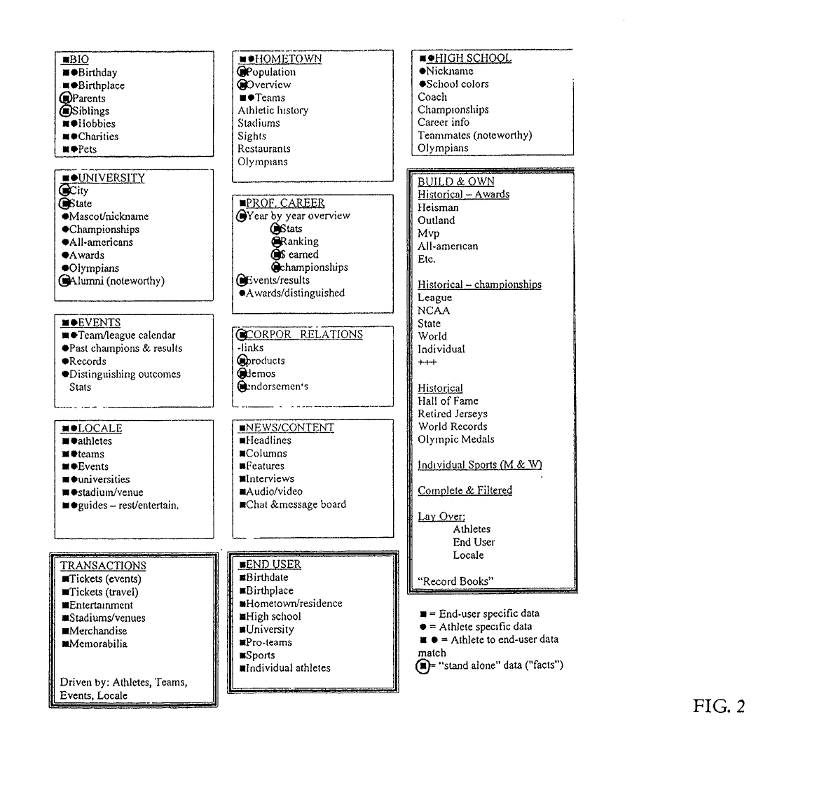

The location identification may correspond to a hometown, birthplace, high school, college, residence, location of a career highlight, among others (see, for example, FIG. 2). Once the method establishes, for example, where an end user (e.g., an athlete) grew up, attended school, and/or lives, the method may query the end user for information (e.g., sports information) relating to those specific location identifications. For example, the method may display on the end user's device a list of hyperlinks to data sets that match the location identifications of the end user. Then, the method may receive a selection from the end user, indicating at least one of the hyperlinks to the data sets. The method displays a result on the end user's device based in part or in whole on the selection from the end user. As such, the specific locations identified may create a sense of ownership to the end user to any and all information related to those locations.

The location identifications may provide a matrix of data sets associated with athletes, teams, stadiums, records, events, among others (see, for example, FIG. 2). The Data sets may include National Champions, All-Americans, Heisman Trophy Winners, Cy Young Award Winners, among others, having ties to any of the location identifications. Each location identification may have a specific data set(s), as well as a nearby data set(s), which may be a geographic location near the location identification. For example, a location identification for Newark, N.J. may have a nearby correlation to New York, N.Y. Other data sets may also be related to the data sets selected by the end user.

Thus, such tagging of information (e.g., sports information) allows, for example, similar (demographic) information from end users to be retrieved and more relevant information to be pushed to an end user. The method may also receive an end user's physical location identification, generated automatically via global positioning software or telecommunications location identification, or inputted manually by the end user using a mobile, wireless, and/or browser-based device. The method may retrieve data with tags that match the end user's physical location identification, and may cause a display on the end user's device of a result of the location identification comparison. As such, the method may provide another filter or query to the end user based on the end user's physical location to relate even more relevant information to that end user. The method then cross references relevant information to the end user, and may also correlate that information with other information such as, for example, athletes to other athlete. This added tagging allows a significant increase in how data is “sliced and diced” and allows additional relevant information to be distributed to the end user.

Thus, the method allows an end user, in effect, to “carry” his or her geographic location profile anywhere and to “reshuffle” a substantial amount of normally latent or unused data, which may be of interest to the end user. The method also allows filtering, organizing, and/or communicating information (e.g., sports information) based on the geographic location profile and/or physical location of an end user. Also, the method may map an end user's geographic location profile to location identification tags across data feeds, and may adapt searching and filtering as the end user roams (e.g., changes his physical location).

That is, the method may import data feeds into a database(s), and tag specific data points with location identifications. Moreover, the method may query the database(s) for a location identification match(es) between the location identifications used to tag specific data points and an end user profile, based on a location(s) of interest to the end user. In addition, the method may add an end user's physical location identification to the end user profile to further focus the query of the database(s).

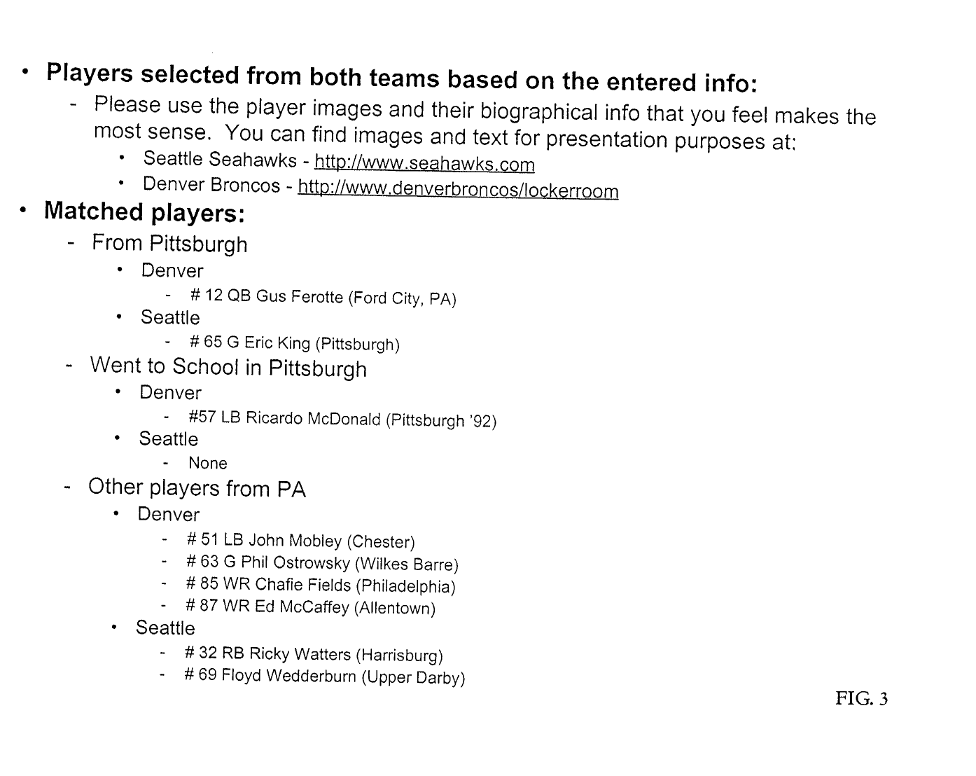

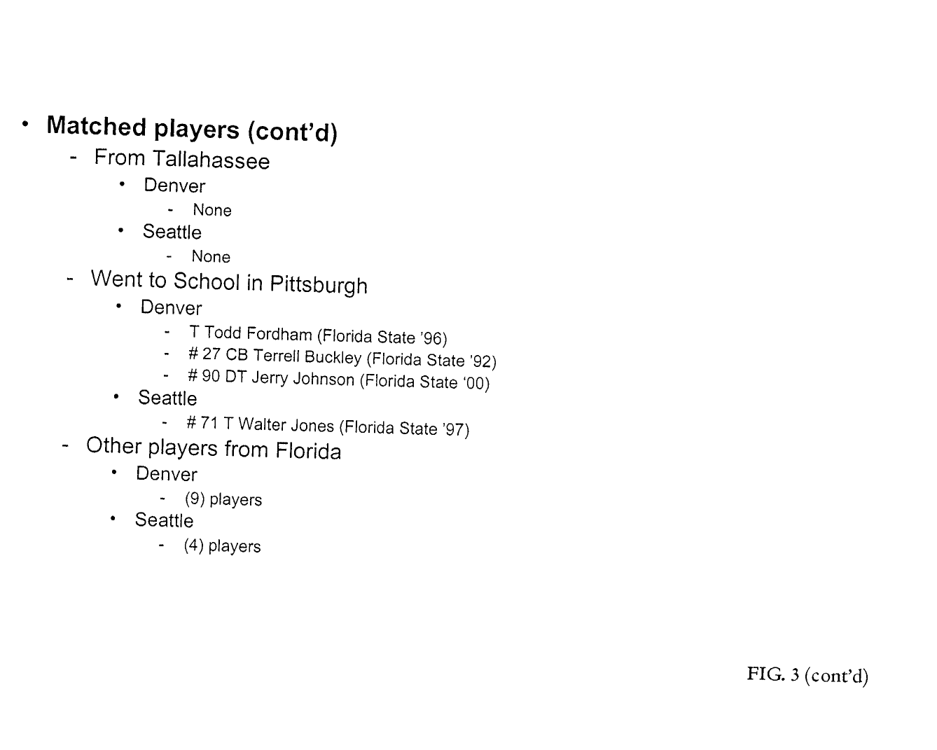

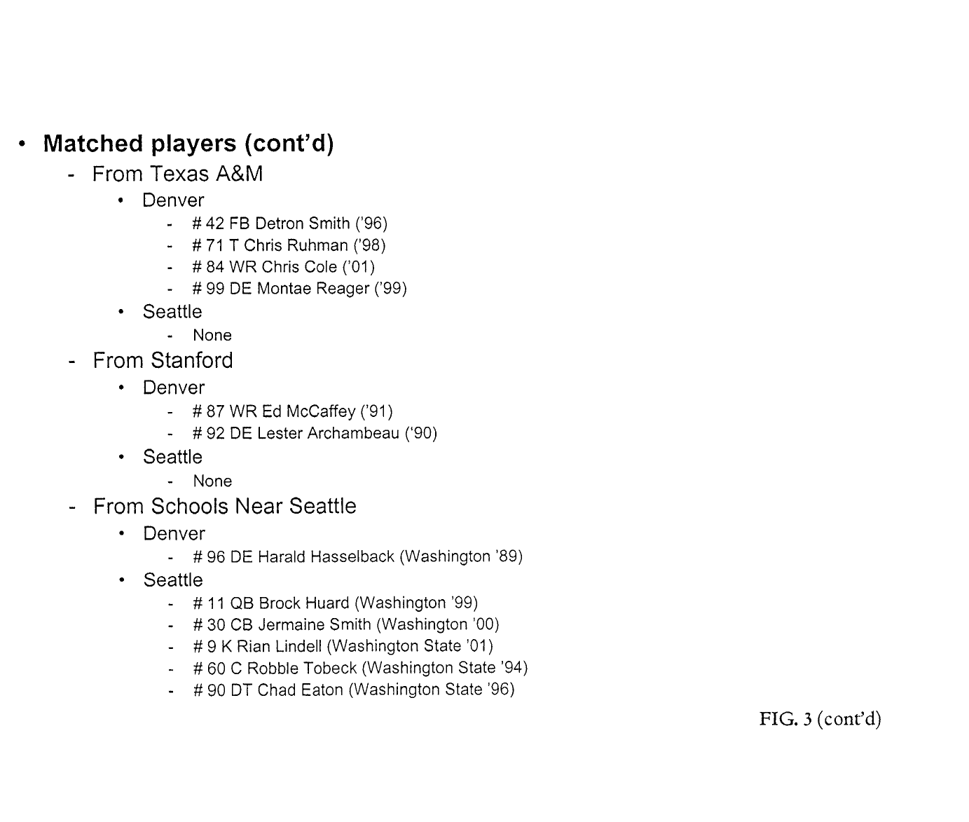

For example, if an end user is a National Football League fan and was born in Pittsburgh, Pa., grew up (e.g., attended high school) in Tallahassee, Fla., attended college at Texas A&M located in College Station, Tex., attended graduate school at Stanford University located in Palo Alto, Calif., and presently lives in Seattle, Wash., then information related to the Seattle Seahawks may be processed based on the locations identified to be of interest to this end user. In this way (as described above), information that is more meaningful to the end user can be customized to him or her. FIG. 3 illustrates the information that may be communicated to the end user, assuming that the Seattle Seahawks next game is against the Denver Broncos.

Another embodiment includes a data structure, stored on a machine readable medium. The data structure may include a first data field, a second data field, and a third data field.

The first data field may contain data representing the end user's location profile for allowing the end user to specify a criteria for a search or query, executed, for example, by a Web-based device. The search or query may provide the end user with access to and an interface for the Web-based device. The end user's location profile, for example, may include a plurality of zip codes of locations of interest to the end user.

The second data field may contain data representing a location identification(s) (e.g., zip code(s)) based on a data feed(s). For instance, Gus Ferotte, QB for the Denver Broncos, was born in Kittanning, Pa., attended high school in Ford City, Pa. and college in Tulsa, Okla., resides in Littleton, Colo., and works in Denver, Colo. As such, a data feed including information on Gus Ferotte may be tagged with a data field including zip codes from and/or nearby zip codes from Kittanning, Pa., Ford City, Pa., Tulsa, Okla., Littleton, Colo., and Denver, Colo.

The third data field may contain data representing data feeds (e.g., sports data feeds) to be made available to the end user as a result of a comparison (e.g., a match) between the first data field and the second data field.

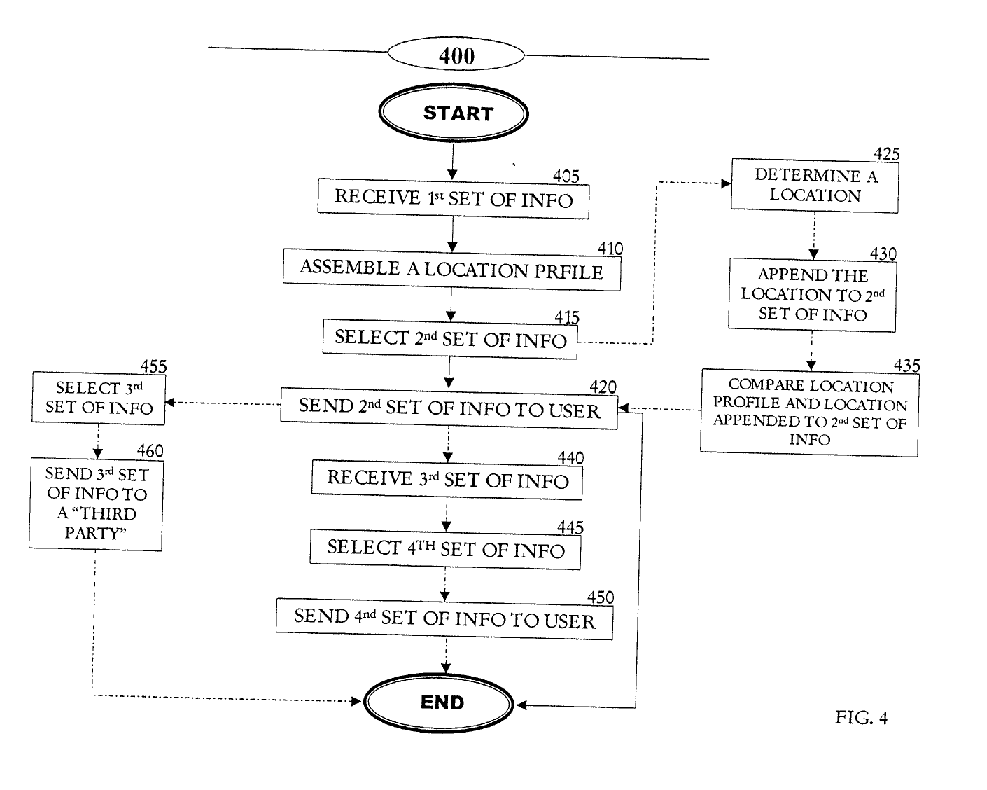

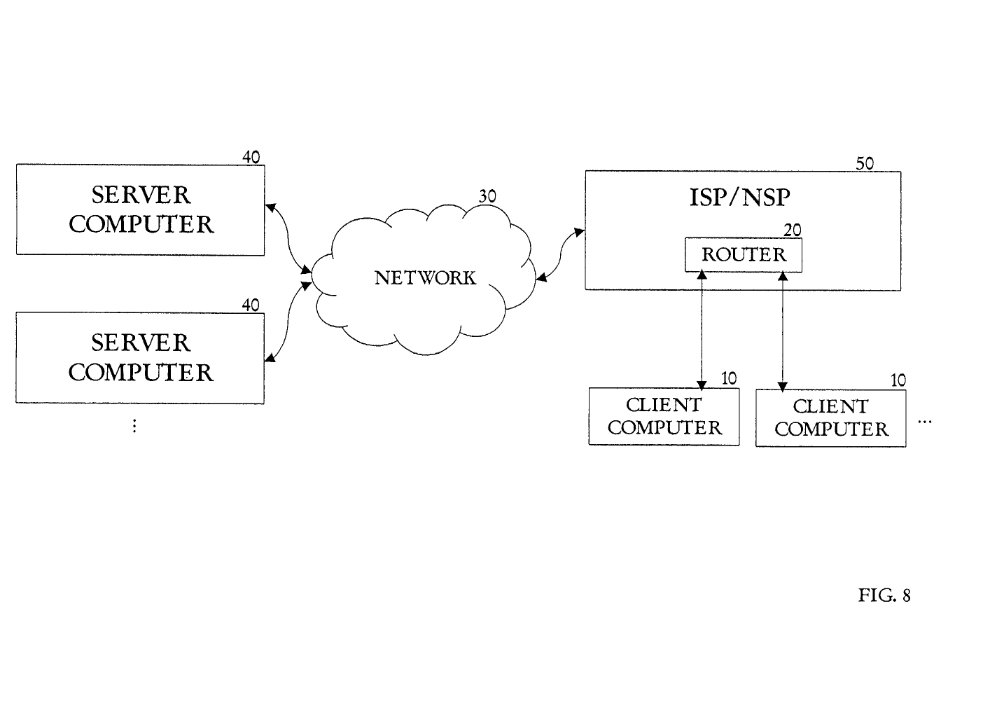

FIG. 4 illustrates one implementation of a method 400 for distributing information based on a geographic location profile of a user. In block 405, the method 400 receives, through a network (e.g., network 30 of FIG. 8), a first set of information.

The first set of information may include information based on at least one of a present and a past geographic location of at least one of (i) the user itself, and (ii) at least one of a friend, an acquaintance, a family member, a colleague, a customer and a competitor of the user. Also, the first set of information may include information based on a geographic location nearby at least one of a present and a past geographic location of at least one of (i) the user itself, and (ii) at least one of a friend, an acquaintance, a family member, a colleague, a customer and a competitor of the user.

The first set of information may be received from the user, through the user's machine (e.g., client computer 10 of FIG. 8), and the present geographic location of the user may be determined by the machine or the user itself. Also, the first set of information may be received from a second machine, and the present geographic location of the user may be determined by the second machine. The second machine may include a global positioning device and/or a telecommunication locating device.

The geographic location of interest to the user may include at least one of the birthplace, hometown, high school, college, residence, and physical geographic location of at least one of (i) the user itself, and (ii) at least one of a friend, an acquaintance, a family member, a colleague, a customer and a competitor of the user. Also, the geographic location of interest to the user may include a geographic location nearby at least one of the birthplace, hometown, high school, college, residence, and physical geographic location of at least one of (i) the user itself, and (ii) at least one of a friend, an acquaintance, a family member, a colleague, a customer and a competitor of the user.

Further, the geographic location of interest to the user may include a zip code of a geographic location of interest to at least one of (i) the user itself, and (ii) at least one of a friend, an acquaintance, a family member, a colleague, a customer and a competitor of the user. Also, the geographic location of interest to the user may include a zip code of a geographic location nearby a geographic location of interest to at least one of (i) the user itself, and (ii) at least one of a friend, an acquaintance, a family member, a colleague, a customer and a competitor of the user.

In block 410, the method 400 assembles a geographic location profile of the user based on the first set of information. The geographic location profile of the user includes a geographic location of interest to the user, and may be stored on a machine-readable medium, for example, coupled to server computer 40 of FIG. 8.

In block 415, the method 400 selects a second set of information based on the geographic location profile of the user. The second set of information may include information on at least one of news, business, entertainment, sports, and people, and may also be stored on the machine-readable medium.

In block 420, the method 400 sends, through the network, the second set of information to the user's machine.

In block 425, the method 400 may (denoted in FIG. 4 by dashed arrow) determine a geographic location based on the second set of information.

In block 430, the method 400 may (denoted in FIG. 4 by dashed arrow) append the geographic location to the second set of information. The geographic location appended to the second set of information may be used to correlate the second set of information with at least one geographic location.

In block 435, the method 400 may (denoted in FIG. 4 by dashed arrow) compare (i) the geographic location profile of the user and (ii) the geographic location appended to the second set of information to select the second set of information.

In block 440, the method 400 may (denoted in FIG. 4 by dashed arrow) receive, through the network, a third set of information from the machine. The third set of information may be based on the second set of information sent to the machine.

In block 445, the method 400 may (denoted in FIG. 4 by dashed arrow) select a fourth set of information based on the third set of information. The fourth set of information may be stored on the machine-readable medium.

In block 450, the method 400 may (denoted in FIG. 4 by dashed arrow) send, through the network, the fourth set of information to the machine. The second set of information sent to the machine may include a link for the user to select the fourth set of information. In turn, the fourth set of information may include information on at least one of news, business, entertainment, sports, and people.

In block 455, the method 400 may (denoted in FIG. 4 by dashed arrow) select a third set of information based on at least one of (i) the first set of information, (ii) the geographic location profile of the user, and (iii) the second set of information. The third set of information may be stored on the machine-readable medium.

In block 460, the method 400 may (denoted in FIG. 4 by dashed arrow) send, through the network, the third set of information to a second machine. The third set of information may identify the user, for example, to a second user of the second machine such as, for example, an entity (e.g., government entity) or individual potentially interested in the user's geographic location profile.

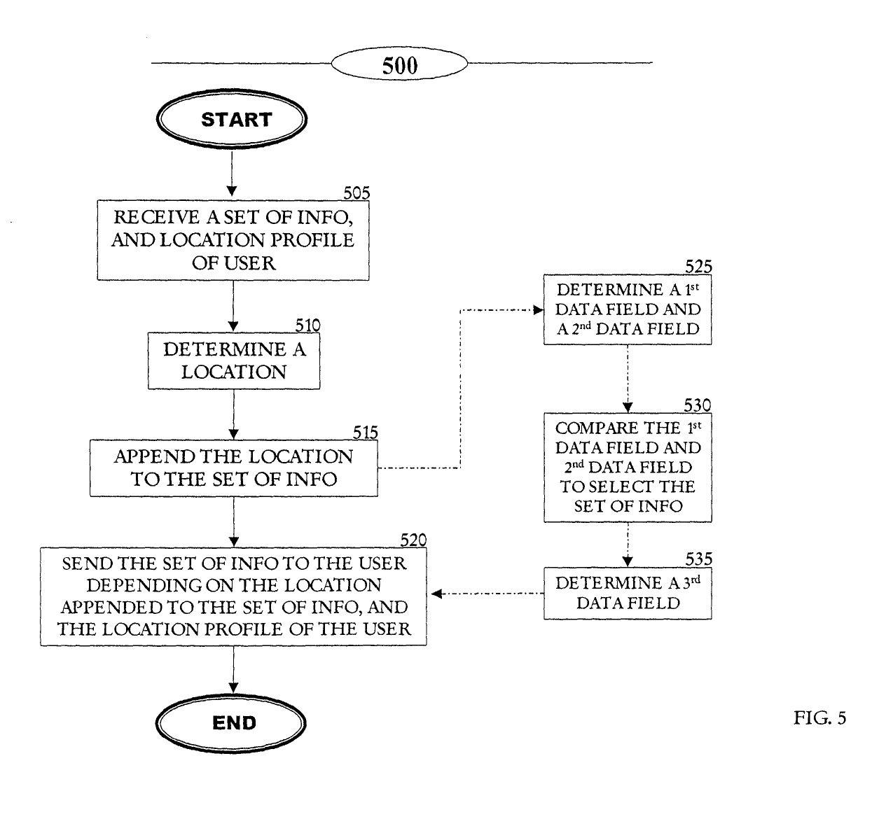

FIG. 5 illustrates one implementation of a method 500 for distributing information based on a geographic location determined for the information. In block 505, the method 500 receives a set of information, and a geographic location profile of a user. The set of information may include information on at least one of news, business, entertainment, sports, and people. The geographic location profile of the user may include a geographic location of interest to the user.

The geographic location profile of the user (see, for example, above) may be based on at least one of a present and a past geographic location of at least one of (i) the user itself, and (ii) at least one of a friend, an acquaintance, a family member, a colleague, a customer and a competitor of the user. Also, the geographic location profile of the user may be based on a geographic location nearby at least one of a present and a past geographic location of at least one of (i) the user itself, and (ii) at least one of a friend, an acquaintance, a family member, a colleague, a customer and a competitor of the user. The present geographic location of the user may be determined by the machine, the user itself, a global positioning device and/or a telecommunication locating device.

In block 510, the method 500 determines a geographic location based on the set of information.

In block 515, the method 500 appends the geographic location to the set of information.

In block 520, the method 500 sends, through a network (e.g., network 30 of FIG. 8), the set of information to a machine (e.g., client computer 10 of FIG. 8) to be used by the user depending on (i) the geographic location appended to the set of information and (ii) the geographic location profile of the user.

In block 525, the method 500 may (denoted in FIG. 5 by dashed arrow) determining a first data field, and a second data field. The first data field may include information based on the geographic location profile of the user. The second data field may include information based on the geographic location appended to the set of information. The second data field may also correlate the set of information with at least one geographic location.

In block 530, the method 500 may (denoted in FIG. 5 by dashed arrow) compare the first data field and the second data field to select the set of information.

In block 535, the method 500 may (denoted in FIG. 5 by dashed arrow) determining a third data field. The third data field may include information based on the comparison between the first data field and the second data field.

The set of information, the first data field, the second data field, and/or the third data field may be stored on a machine-readable medium, for example, coupled to server computer 40 of FIG. 8.

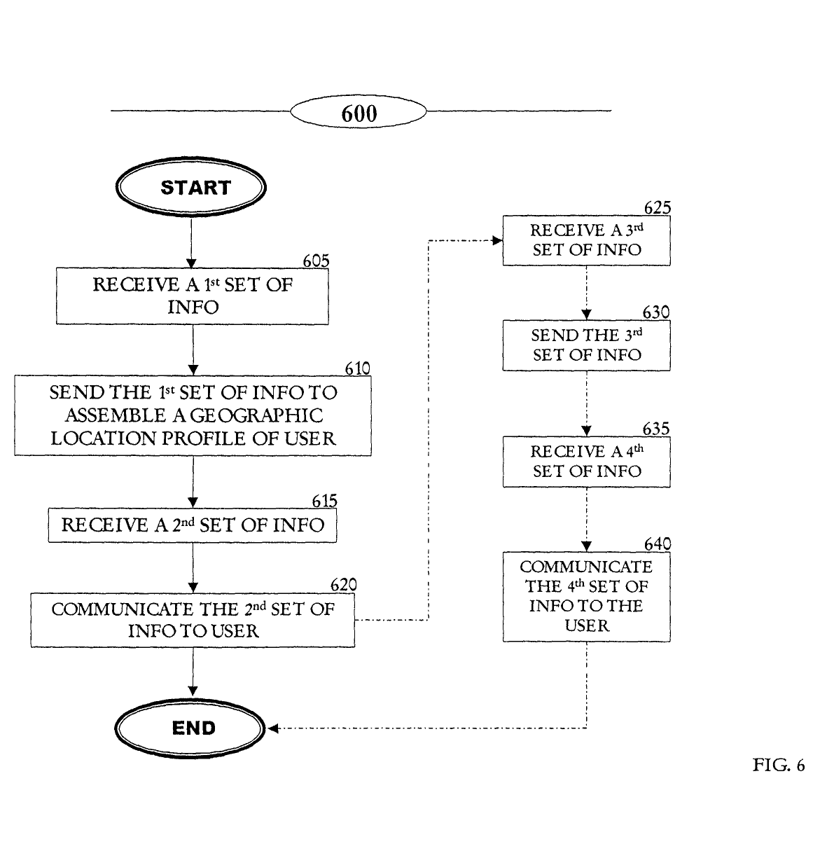

FIG. 6 illustrates one implementation of a method 600 of consuming information based on a geographic location profile of a user. In block 605, the method 600 receives a first set of information (e.g., see description of method 400 concerning same term), based on a geographic location of interest to a user (e.g., see description of method 400 concerning same term).

In block 610, the method 600 sends, through a network (e.g., network 30 of FIG. 8), the first set of information, for example, to server computer 40 of FIG. 8, to assemble a geographic location profile of the user. The geographic location profile of the user is based on the first set of information.

In block 615, the method 600 receives, through the network, a second set of information, based on the geographic location profile of the user. The second set of information may be selected to be sent through the network by a comparison between the geographic location profile of the user and a geographic location determined based on the second set of information. The geographic location determined based on the second set of information may be appended to the second set of information to correlate the second set of information with at least one geographic location.

In block 620, the method 600 communicates, for example, through client computer 10 of FIG. 8, the second set of information to the user. The second set of information may include information on at least one of news, business, entertainment, sports, and people.

In block 625, the method 600 may (denoted in FIG. 6 by dashed arrow) receive a third set of information, based on the second set of information.

In block 630, the method 600 may (denoted in FIG. 6 by dashed arrow) send, through the network, the third set of information.

In block 635, the method 600 may (denoted in FIG. 6 by dashed arrow) receive, through the network, a fourth set of information, based on the third set of information.

In block 640, the method 600 may (denoted in FIG. 6 by dashed arrow) communicate the fourth set of information to the user. The second set of information communicated to the user may include a link for the user to select the fourth set of information. The fourth set of information may include information on at least one of news, business, entertainment, sports, and people.

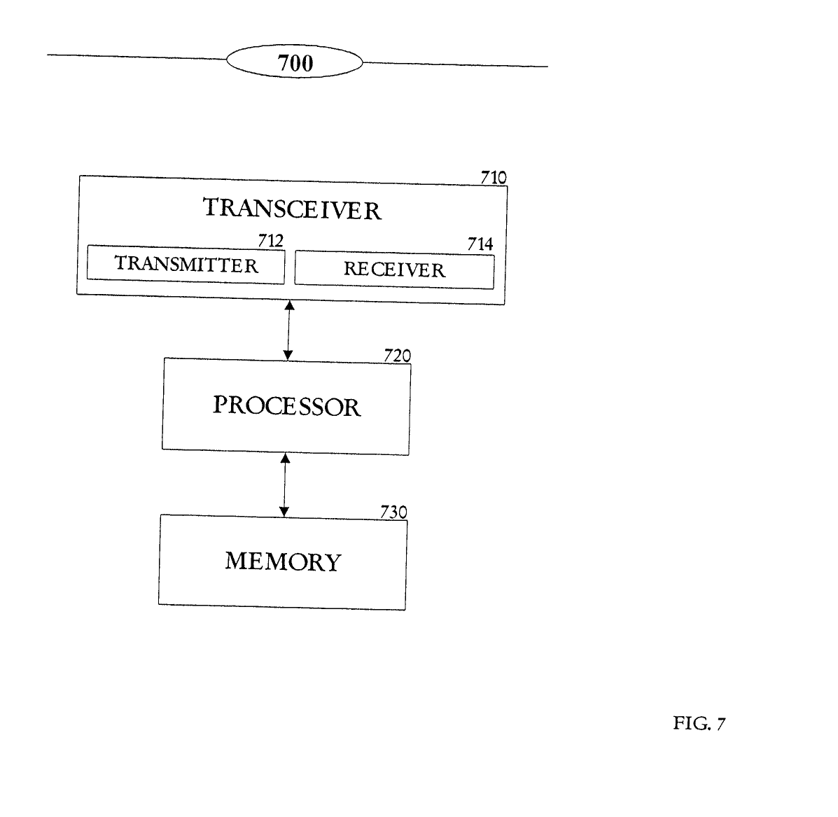

FIG. 7 illustrates one implementation of an apparatus 700, for example, for (i) distributing information based on a geographic location profile of a user, (ii) distributing information based on a geographic location determined for the information, and/or (iii) consuming information based on a geographic location profile of a user. The apparatus 700 may comprise a transceiver 710, a processor 720, a memory 730, a speaker (not shown), a microphone (not shown), a display (not shown), and/or a keypad (not shown). The transceiver 710 includes a transmitter 712 that allows the apparatus 700 to transmit information, for example, to a network (not shown) over a communications link (not shown). The network may include a wide area network (WAN) (e.g., Internet), or a local area network (LAN) (e.g., Intranet), or the like, where the communications link may be a direct land line, or a radio communications link, such as a microwave link, satellite link, or the like. The transceiver 710 also includes a receiver 714 that allows the apparatus 700 to receive information, for example, from the network over the communications link. Such transmission and reception operations over the communications link may be conducted using the same or different data rates, communications protocols, carrier frequencies, and/or modulation schemes. Likewise, the operations and/or circuit configurations of the transmitter 712 and the receiver 714, respectively, may be completely independent of one another or, alternatively, may be partially or fully integrated.

The processor 720, which may comprise one or more microprocessors, microcontrollers, or other arrays of logic elements, controls the operation of the apparatus 700 according to a sequence of commands that may be (i) stored in the memory 730 or in another storage device within or coupled to the apparatus 700, (ii) entered by a user through an interface such as a data entry device (e.g., a keypad) (not shown), and/or (iii) received from the network over the communications link.

The memory 730, which may comprise read-only memory (ROM), random-access memory (RAM), nonvolatile memory, an optical disk, a magnetic tape, and/or magnetic disk, stores programmable parameters and may also store information including executable instructions, non-programmable parameters, and/or other data. For example, a geographic location profile of a user may be stored in the memory 730 and/or may be stored elsewhere within the apparatus 700. Executable instructions defining a method associated with the presented embodiments may also be stored in the memory 730 for execution by the processor 720. The method may be programmed when the apparatus 700 is manufactured or via a machine-readable medium at a later date. Such a medium may include any of the forms listed above with respect to the memory 730 and may further include, for example, a carrier wave modulated, or otherwise manipulated, to convey instructions that can be read, demodulated/decoded and executed by the apparatus 700.

In another embodiment, a system includes a first machine (e.g., client computer 10 of FIG. 8), coupled to a display device (not shown), a second machine (e.g., server computer 40 of FIG. 8), coupled to a machine-readable medium (not shown), and a network (e.g., network 30 of FIG. 8), coupled to the first machine and the second machine. The second machine may (i) receive, through the network, a first set of information, based on a geographic location of interest to a user, for example, from the first machine or other machine, (ii) assemble a geographic location profile of the user based on the first set of information, (iii) select a second set of information based on the geographic location profile of the user, and (iv) send, through the network, the second set of information to the first machine. The first machine may receive, through the network, the second set of information from the second machine to display, through the display device, the second set of information to the user. The machine-readable medium may store the geographic location profile of the user and the second set of information.

The machine-readable medium may also store a third set of information. The second machine may also select the third set of information based on (i) the first set of information, (ii) the geographic location profile of the user, and/or (iii) the second set of information. The second machine may then send, through the network, the third set of information to a third machine. The third set of information may identify the user of the first machine to the user of the third machine. Each of the first machine, second machine, and third machine of the system may include an apparatus 700.

In view of the foregoing, it will be apparent to one of ordinary skill in the art that the described embodiments may be implemented in software, firmware, and/or hardware. The actual software code or specialized control hardware used to implement the present invention is not limiting of the invention. Thus, the operation and behavior of the embodiments is described without specific reference to the actual software code or specialized hardware components. The absence of such specific references is feasible because it is clearly understood that artisans of ordinary skill would be able to design software and/or control hardware to implement the embodiments of the present invention based on the description herein.

The foregoing presentation of the described embodiments is provided to enable any person skilled in the art to make or use the present invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, or as a firmware program loaded into non-volatile memory or a software program loaded from or into a data storage medium as machine-readable code, such code being instructions executable by an array of logic elements such as a microprocessor or other digital signal processing unit, or some other programmable machine or system. As such, the present invention is not intended to be limited to the embodiments shown above, any particular sequence of instructions, and/or any particular configuration of hardware but rather is to be accorded the widest scope consistent with the principles and novel features disclosed in any fashion herein.

What is claimed is:

1. A method comprising:
receiving a first set of information, based on a geographic location of interest to a user;
sending, through a network, the first set of information to assemble a geographic location profile of the user;
receiving, through the network, a second set of information, based on the geographic location profile of the user; and
communicating the second set of information to the user,
wherein the geographic location profile of the user is based on the first set of information.

2. The method of claim 1, wherein the second set of information includes information on at least one of news, business, entertainment, sports, and people.

3. The method of claim 1, wherein the second set of information is selected to be sent through the network by a comparison between the geographic location profile of the user and a geographic location determined based on the second set of information.

4. The method of claim 3, wherein the geographic location determined based on the second set of information is appended to the second set of information to correlate the second set of information with at least one geographic location.

5. The method of claim 1, further comprising
receiving a third set of information, based on the second set of information; and
sending, through the network, the third set of information.

6. The method of claim 5, further comprising
receiving, through the network, a fourth set of information, based on the third set of information; and
communicating the fourth set of information to the user.

7. The method of claim 6, wherein the second set of information communicated to the user includes a link for the user to select the fourth set of information.

8. The method of claim 6, wherein the fourth set of information includes information on at least one of news, business, entertainment, sports, and people.

9. The method of claim 1, wherein the geographic location of interest to the user includes at least one of the birthplace, hometown, high school, college, residence, and physical geographic location of at least one of (i) the user itself, and (ii) at least one of a friend, an acquaintance, a family member, a colleague, a customer and a competitor of the user.

10. The method of claim 1, wherein the geographic location of interest to the user includes a geographic location nearby at least one of the birthplace, hometown, high school, college, residence, and physical geographic location of at least one of (i) the user itself, and (ii) at least one of a friend, an acquaintance, a family member, a colleague, a customer and a competitor of the user.

11. The method of claim 1, wherein the geographic location of interest to the user includes a zip code of a geographic location of interest to at least one of (i) the user itself, and (ii) at least one of a friend, an acquaintance, a family member, a colleague, a customer and a competitor of the user.

12. The method of claim 1, wherein the geographic location of interest to the user includes a zip code of a geographic location nearby a geographic location of interest to at least one of (i) the user itself, and (ii) at least one of a friend, an acquaintance, a family member, a colleague, a customer and a competitor of the user.

13. The method of claim 1, wherein the first set of information includes information based on at least one of a present and a past geographic location of at least one of (i) the user itself, and (ii) at least one of a friend, an acquaintance, a family member, a colleague, a customer and a competitor of the user.

14. The method of claim 13, wherein the present geographic location of the user is determined by at least one of a global positioning device and a telecommunication locating device.

15. The method of claim 13, wherein the user determines the present geographic location of itself.

16. The method of claim 1, wherein the first set of information includes information based on a geographic location nearby at least one of a present and a past geographic location of at least one of (i) the user itself, and (ii) at least one of a friend, an acquaintance, a family member, a colleague, a customer and a competitor of the user.

17. An apparatus comprising:
a processor to receive a first set of information, based on a geographic location of interest to a user;
a transmitter to send, through a network, the first set of information to assemble a geographic location profile of the user;
a receiver to receive, through the network, a second set of information, based on the geographic location profile of the user; and
a display device to display the second set of information to the user,
wherein the transmitter, the receiver, and the display device are coupled to the processor, and
wherein the geographic location profile of the user is based on the first set of information.

18. The apparatus of claim 17, wherein the second set of information includes information on at least one of news, business, entertainment, sports, and people.

19. The apparatus of claim 17, wherein the second set of information is selected to be sent through the network by a comparison between the geographic location profile of the user and a geographic location determined based on the second set of information.

20. The apparatus of claim 19, wherein the geographic location determined based on the second set of information is appended to the second set of information to correlate the second set of information with at least one geographic location.

21. The apparatus of claim 17,
wherein the processor is configured to receive a third set of information, based on the second set of information, and
wherein the transmitter is configured to send, through the network, the third set of information.

22. The apparatus of claim 21,
wherein the receiver is configured to receive, through the network, a fourth set of information, based on the third set of information, and
wherein the display device is configured to display the fourth set of information to the user.

23. The apparatus of claim 22, wherein the second set of information displayed to the user includes a link for the user to select the fourth set of information.

24. The apparatus of claim 22, wherein the fourth set of information includes information on at least one of news, business, entertainment, sports, and people.

25. The apparatus of claim 17, wherein the geographic location of interest to the user includes at least one of the birthplace, hometown, high school, college, residence, and physical geographic location of at least one of (i) the user itself, and (ii) at least one of a friend, an acquaintance, a family member, a colleague, a customer and a competitor of the user.

26. The apparatus of claim 17, wherein the geographic location of interest to the user includes a geographic location nearby at least one of the birthplace, hometown, high school, college, residence, and physical geographic location of at least one of (i) the user itself, and (ii) at least one of a friend, an acquaintance, a family member, a colleague, a customer and a competitor of the user.

27. The apparatus of claim 17, wherein the geographic location of interest to the user includes a zip code of a geographic location of interest to at least one of (i) the user itself, and (ii) at least one of a friend, an acquaintance, a family member, a colleague, a customer and a competitor of the user.

28. The apparatus of claim 17 wherein the geographic location of interest to the user includes a zip code of a geographic location nearby a geographic location of interest to at least one of (i) the user itself, and (ii) at least one of a friend, an acquaintance, a family member, a colleague, a customer and a competitor of the user.

29. The apparatus of claim 17, wherein the first set of information includes information based on at least one of a present and a past geographic location of at least one of (i) the user itself, and (ii) at least one of a friend, an acquaintance, a family member, a colleague, a customer and a competitor of the user.

30. The apparatus of claim 29, further comprising
at least one of a global positioning device and a telecommunication locating device to determine the present geographic location of the user, and
wherein the at least one of the global positioning device and the telecommunication locating device is coupled to the processor.

31. The apparatus of claim 29, wherein the user determines the present geographic location of itself.

32. The apparatus of claim 17, wherein the first set of information includes information based on a geographic location nearby at least one of a present and a past geographic location of at least one of (i) the user itself, and (ii) at least one of a friend, an acquaintance, a family member, a colleague, a customer and a competitor of the user.

33. A machine-readable medium having encoded information, which when read and executed by a machine causes a method comprising:
receiving a first set of information, based on a geographic location of interest to a user;
sending, through a network, the first set of information to assemble a geographic location profile of the user;
receiving, through the network, a second set of information, based on the geographic location profile of the user; and
communicating the second set of information to the user,
wherein the geographic location profile of the user is based on the first set of information.

34. The machine-readable medium of claim 33, wherein the second set of information includes information on at least one of news, business, entertainment, sports, and people.

35. The machine-readable medium of claim 33, wherein the second set of information is selected to be sent through the network by a comparison between the geographic location profile of the user and a geographic location determined based on the second set of information.

36. The machine-readable medium of claim 35, wherein the geographic location determined based on the second set of information is appended to the second set of information to correlate the second set of information with at least one geographic location.

37. The machine-readable medium of claim 33, the method further comprising
receiving a third set of information, based on the second set of information; and
sending, through the network, the third set of information.

38. The machine-readable medium of claim 37, the method further comprising
receiving, through the network, a fourth set of information, based on the third set of information; and
communicating the fourth set of information to the user.

39. The machine-readable medium of claim 38, wherein the second set of information communicated to the user includes a link for the user to select the fourth set of information.

40. The machine-readable medium of claim 38, wherein the fourth set of information includes information on at least one of news, business, entertainment, sports, and people.

41. The machine-readable medium of claim 33, wherein the geographic location of interest to the user includes at least one of the birthplace, hometown, high school, college, residence, and physical geographic location of at least one of (i) the user itself, and (ii) at least one of a friend, an acquaintance, a family member, a colleague, a customer and a competitor of the user.

42. The machine-readable medium of claim 33, wherein the geographic location of interest to the user includes a geographic location nearby at least one of the birthplace, hometown, high school, college, residence, and physical geographic location of at least one of (i) the user itself, and (ii) at least one of a friend, an acquaintance, a family member, a colleague, a customer and a competitor of the user.

43. The machine-readable medium of claim 33, wherein the geographic location of interest to the user includes a zip code of a geographic location of interest to at least one of (i) the user itself, and (ii) at least one of a friend, an acquaintance, a family member, a colleague, a customer and a competitor of the user.

44. The machine-readable medium of claim 33, wherein the geographic location of interest to the user includes a zip code of a geographic location nearby a geographic location of interest to at least one of (i) the user itself, and (ii) at least one of a friend, an acquaintance, a family member, a colleague, a customer and a competitor of the user.

45. The machine-readable medium of claim 33, wherein the first set of information includes information based on at least one of a present and a past geographic location of at least one of (i) the user itself, and (ii) at least one of a friend, an acquaintance, a family member, a colleague, a customer and a competitor of the user.

46. The machine-readable medium of claim 45, wherein the present geographic location of the user is determined by at least one of a global positioning device and a telecommunication locating device.

47. The machine-readable medium of claim 45, wherein the user determines the present geographic location of itself.

48. The machine-readable medium of claim 33, wherein the first set of information includes information based on a geographic location nearby at least one of a present and a past geographic location of at least one of (i) the user itself, and (ii) at least one of a friend, an acquaintance, a family member, a colleague, a customer and a competitor of the user.

49. A system comprising:
a first machine, coupled to a display device;
a second machine, coupled to a machine-readable medium; and
a network, coupled to the first machine and the second machine,
wherein the second machine (i) receives, through the network, a first set of information, based on a geographic location of interest to a user, (ii) assembles a geographic location profile of the user based on the first set of information, (iii) selects a second set of information based on the geographic location profile of the user, and (iv) sends, through the network, the second set of information to the first machine,
wherein the first machine receives, through the network, the second set of information from the second machine to display, through the display device, the second set of information to the user, and
wherein the machine-readable medium stores the geographic location profile of the user and the second set of information.

50. The system of claim 49, wherein the second set of information includes information on at least one of news, business, entertainment, sports, and people.

51. The system of claim 49,
wherein the second machine is configured to:
determine a geographic location based on the second set of information,
append the geographic location to the second set of information, and
compare (i) the geographic location profile of the user and (ii) the geographic location appended to the second set of information to select the second set of information.

52. The system of claim 51, wherein the geographic location appended to the second set of information is used to correlate the second set of information with at least one geographic location.

53. The system of claim 49,
wherein the second machine is configured to receive, through the network, a third set of information from the first machine, and
wherein the third set of information is based on the second set of information sent to the first machine.

54. The system of claim 53,
wherein the machine-readable medium is configured to store a fourth set of information, and
wherein the second machine, coupled to the machine-readable medium, is configured to (i) select the fourth set of information based on the third set of information, and (ii) to send, through the network, the fourth set of information to the first machine.

55. The system of claim 54, wherein the second set of information sent to the first machine includes a link for the user to select the fourth set of information.

56. The system of claim 54, wherein the fourth set of information includes information on at least one of news, business, entertainment, sports, and people.

57. The system of claim 49, wherein the geographic location of interest to the user includes at least one of the birthplace, hometown, high school, college, residence, and physical geographic location of at least one of (i) the user itself, and (ii) at least one of a friend, an acquaintance, a family member, a colleague, a customer and a competitor of the user.

58. The system of claim 49, wherein the geographic location of interest to the user includes a geographic location nearby at least one of the birthplace, hometown, high school, college, residence, and physical geographic location of at least one of (i) the user itself, and (ii) at least one of a friend, an acquaintance, a family member, a colleague, a customer and a competitor of the user.

59. The system of claim 49, wherein the geographic location of interest to the user includes a zip code of a geographic location of interest to at least one of (i) the user itself, and (ii) at least one of a friend, an acquaintance, a family member, a colleague, a customer and a competitor of the user.

60. The system of claim 49, wherein the geographic location of interest to the user includes a zip code of a geographic location nearby a geographic location of interest to at least one of (i) the user itself, and (ii) at least one of a friend, an acquaintance, a family member, a colleague, a customer and a competitor of the user.

61. The system of claim 49, wherein the first set of information includes information based on at least one of a present and a past geographic location of at least one of (i) the user itself, and (ii) at least one of a friend, an acquaintance, a family member, a colleague, a customer and a competitor of the user.

62. The system of claim 61,
wherein the second machine is configured to receive the first set of information from the first machine, and
wherein at least one of the first machine and the user itself of the first machine determines the present geographic location of the user.

63. The system of claim 61,
wherein the second machine is configured to receive the first set of information from at least one of the first machine and a third machine, and
wherein the second machine determines the present geographic location of the user.

64. The system of claim 63, wherein at least one of the first machine and the third machine includes at least one of a global positioning device and a telecommunication locating device.

65. The system of claim 49, wherein the first set of information includes information based on a geographic location nearby at least one of a present and a past geographic location of at least one of (i) the user itself, and (ii) at least one of a friend, an acquaintance, a family member, a colleague, a customer and a competitor of the user.

66. The system of claim 49,
wherein the machine-readable medium is configured to store a third set of information, and
wherein the second machine is configured to select the third set of information based on at least one of (i) the first set of information, (ii) the geographic location profile of the user, and (iii) the second set of information, and to send, through the network, the third set of information to a third machine.

67. The system of claim 66, wherein the third set of information identifies the first mentioned user of the first machine to a second user of the third machine.
